(19) United States
(12) Patent Application Publication
(10) Pub. No.: US 2015/0270515 A1
(43) Pub. Date: Sep. 24, 2015

(54) SECONDARY BATTERY AND MANUFACTURING METHOD FOR THE SAME

(71) Applicant: Samsung SDI Co., Ltd., Yongin-si (KR)

(72) Inventors: Kyung-Jae Shin, Yongin-si (KR); Jae-Hoon Choi, Yongin-si (KR); Sung-Kyun Lim, Yongin-si (KR)

(21) Appl. No.: 14/618,371

(22) Filed: Feb. 10, 2015

(30) Foreign Application Priority Data
Mar. 19, 2014 (KR) 10-2014-0032081

(51) Int. Cl. H01M 2/02

(52) U.S. Cl. CPC H01M 2/0267; H01M 2/028

(57) ABSTRACT

A secondary battery and a manufacturing method for the same are disclosed. In one aspect, the method comprises cutting a wound tubing member to a predetermined length and inserting a battery cell including first and second electrode tabs into the cut tubing member. The method further comprises performing a primary heat-contraction process on the tubing member, wherein the primary heat-contraction process comprises applying heat to upper and lower portions of the battery cell. The method also comprises performing a secondary heat-contraction process on the tubing member, wherein the secondary heat-contraction process comprises applying heat to substantially the entire surface of the battery cell.

### INCORPORATION BY REFERENCE TO ANY PRIORITY APPLICATIONS

This application claims priority to and the benefit of Korean Patent Application No. 10-2014-0032081, filed on Mar. 19, 2014, in the Korean Intellectual Property Office, the entire contents of which are incorporated herein by reference in their entirety.

### BACKGROUND

1. Field

The described technology generally relates to a secondary battery and a manufacturing method for the same.

2. Description of the Related Technology

As the electronics and communications industries are rapidly developing, the use of portable electronic devices such as camcorders, cell phones and laptop computers has also increased. Accordingly, the usage of secondary, or rechargeable, batteries has also increased. Secondary batteries are used for not only portable electronic devices but also medium- and large-sized platforms such as electric tools, automobiles, motorbikes, motor scooters and aerospace applications, which require high output and high power.

In general, a secondary battery is formed with a cylindrical, prismatic or pouch-type case. Generally, insulation tape is applied on the exterior of the case. Because the taping process is manually performed, production cost can increase. Accordingly, various studies have been conducted to improve the efficiency of working while reducing production cost.

### SUMMARY OF CERTAIN INVENTIVE ASPECTS

One inventive aspect is a structure capable of improving the safety of the secondary battery in overcurrent.

Another aspect is a tubing member having a hole formed therein so that some space between a tubing member and a battery cell can be secure in thermal expansion of the battery cell.

Another aspect is a secondary battery which can be manufactured by an automation process.

Another aspect is a manufacturing method for a secondary battery, which can prevent the ionization of aluminum in a case of a battery cell and the occurrence of a side reaction between the aluminum and an electrolyte.

Another aspect is a secondary battery, including: an electrode assembly configured to have first and second electrode tabs; a case configured to accommodate the electrode assembly and an electrolyte therein; and a tubing member configured to surround an outer surface of the case, the tubing member having opened upper and lower portions.

A contraction portion can be formed in one area of the upper or lower portions of the tubing member.

The contraction portion can have an arch shape.

One side of the tubing member can include a bonding area in which the tubing member is bonded by an ultrasonic or high-frequency bonding machine, and a non-bonding area in which the tubing member is not bonded. The first and second electrode tabs can be exposed to the outside to the tubing member in the non-bonding area.

A hole can be formed in at least one surface of the tubing member.

The tubing member can be formed of polyethyleneterephthalate (PET) or polyimide (PI).

The case can be a prismatic or pouch-type case.

Another aspect is a method for manufacturing a secondary battery, the method including: cutting a wound tubing member to a predetermined length; inserting a battery cell having first and second electrode tabs into the cut tubing member; performing a primary heat-contraction process on the tubing member by applying heat to upper and lower portions of the battery cell inserted into the tubing member; and performing a secondary heat-contraction process on the tubing member by applying heat to the entire surface of the battery cell inserted into the heat-contracted tubing member.

The primary heat-contraction process can be performed under a temperature of 200 to 240° C. for 2 to 8 seconds.

The secondary heat-contraction process can be performed under a thermostat of 200 to 240° C.

The method can further include, after the cutting of the tubing member, partially bonding one area of the cut tubing member or forming a hole in one surface of the cut tubing member.

The partially bonding can be performed in other areas except areas respectively corresponding to the first and second electrode tabs.

The hole can be formed at a central portion of the tubing member.

Another aspect is a secondary battery comprising an electrode assembly including first and second electrode tabs, a case accommodating the electrode assembly and an electrolyte therein, wherein the case includes first and second sides opposing each other, and a tubing member surrounding an outer surface of the case, wherein the tubing member has first and second openings respectively exposing the first and second sides of the case.

The above secondary battery further comprises a contraction portion formed adjacent to one of the first and second openings of the tubing member. In the above secondary battery, the contraction portion has an arch shape.

In the above secondary battery, one side of the tubing member includes i) a bonding area in which the tubing member is bonded to the case and ii) a non-bonding area in which the tubing member is not bonded, wherein the first and second electrode tabs are exposed to the exterior of the tubing member in the non-bonding area.

In the above secondary battery, the tubing member has at least one third opening formed between the first and second openings. In the above secondary battery, the third opening has a shape different from the first and second openings.

In the above secondary battery, the third opening has an elliptical shape.

In the above secondary battery, the tubing member is formed of polyethyleneterephthalate (PET) or polyimide (PI).

In the above secondary battery, the case is a prismatic or pouch-type case.

In the above secondary battery, the first opening is greater in size than the second opening.

In the above secondary battery, the first and second electrode tabs are formed in the second opening.

Another aspect is a method for manufacturing a secondary battery, the method comprising cutting a wound tubing member to a predetermined length, inserting a battery cell including first and second electrode tabs into the cut tubing member, performing a primary heat-contraction process on the tubing member, wherein the primary heat-contraction process comprises applying heat to upper and lower portions of the battery cell, and performing a secondary heat-contraction process on the tubing member, wherein the secondary heat-contraction process comprises applying heat to substantially the entire surface of the battery cell.

In the above method, the primary heat-contraction process is performed with a temperature of about 200° C. to about 240° C. for about 2 seconds to about 8 seconds.

In the above method, the secondary heat-contraction process is performed with a temperature of about 200° C. to about 240° C.

The above method further comprises partially bonding one area of the cut tubing member. In the above method, the partially bonding is performed in areas except for areas corresponding to the first and second electrode tabs.

The method further comprises forming an opening in at least one surface of the cut tubing member. In the above method, the opening is formed at a central portion of the tubing member.

In the above method, the opening is between the upper and lower portions of the battery cell.

In the above method, the tubing member is formed of polyethyleneterephthalate (PET) or polyimide (PI).

As described above, according to the secondary battery of the described technology, the secondary battery is tubed by applying the tubing member having the opened upper and lower portions to the secondary battery, so that the automation of the secondary battery is possible. Accordingly, it is possible to reduce personnel expenses and manufacturing costs.

Further, as the hole is formed in one area of the tubing member, the tubing member can have elasticity. Accordingly, it is possible to secure some space in thermal expansion of the secondary battery, thereby improving the safety of the secondary battery.

According to the method for manufacturing the secondary battery of the described technology, the primary and secondary heat-contraction processes are respectively performed by different methods, so that the contraction ratio of the tubing member can be minimized. Accordingly, it is possible to prevent the ionization of aluminum in the case and the occurrence of a side reaction between the aluminum and the electrolyte, thereby preventing corrosion of the secondary battery.

### BRIEF DESCRIPTION OF THE DRAWINGS

FIG. 1 is a perspective view showing a secondary battery according to an embodiment.

FIG. 2 is a sectional view taken along line I-I′ of FIG. 1.

FIG. 3 is a perspective view showing a secondary battery according to another embodiment.

FIG. 4 is a perspective view showing a tubing member of FIG. 3.

FIG. 5 is a flowchart illustrating a method for manufacturing the secondary battery according to an embodiment.

### DETAILED DESCRIPTION OF CERTAIN INVENTIVE EMBODIMENTS

In the following detailed description, only certain exemplary embodiments of the described technology have been shown and described, simply by way of illustration. As those skilled in the art would realize, the described embodiments can be modified in various different ways, all without departing from the spirit or scope of the described technology. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

Example embodiments will now be described more fully hereinafter with reference to the accompanying drawings; however, they can be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions can be exaggerated for clarity of illustration. It will be understood that when an element is referred to as being “between” two elements, it can be the only element between the two elements, or one or more intervening elements can also be present. Like reference numerals refer to like elements throughout. In this disclosure, the term “substantially” includes the meanings of completely, almost completely or to any significant degree under some applications and in accordance with those skilled in the art. Moreover, “formed on” can also mean “formed over.”

FIG. 1 is a perspective view showing a secondary battery according to an embodiment.

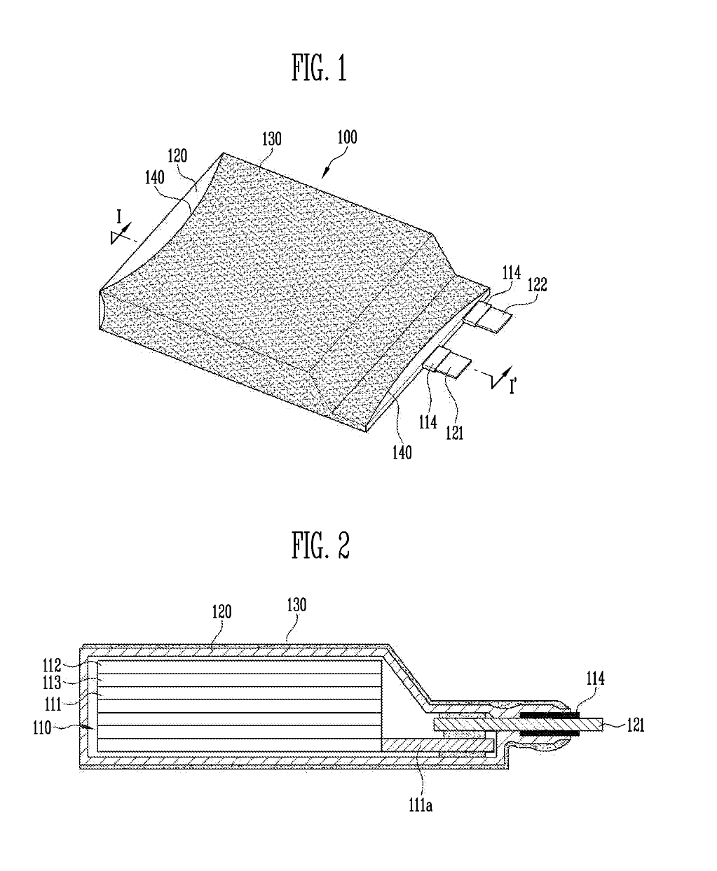

As shown in FIG. 1, a secondary battery 100 according to this embodiment includes an electrode assembly 110 (see FIG. 2) having first and second electrode tabs 121 and 122. The secondary battery 100 also includes a case 120 configured to accommodate the electrode assembly 110 and an electrolyte therein. The secondary battery 100 also includes a tubing member 130 configured to surround an outer surface of the case 120 and the tubing member 130 has opened upper and lower portions.

The tubing member 130 can be formed of polyethyleneterephthalate (PET) or polyimide (PI) for the purpose of electrical insulation. An arch-shaped contraction portion 140 can be formed in at least one area of at least one of the upper and lower portions of the tubing member 130. When the contraction portion 140 is formed as described, it is possible to prevent interference between battery cells and an increase in thickness of the secondary battery. Further, it is possible to ensure the insulation of the battery cells.

The tubing member 130 can be formed of a transparent material so that a state of the battery cell can be identified therethrough.

FIG. 2 is a sectional view taken along line I-I′ of FIG. 1.

The secondary battery will be briefly described with reference to FIG. 2.

The secondary battery 100 according to the described technology includes the electrode assembly 110 configured to include a first electrode plate 111, a second electrode plate 112 and a separator 113 interposed between the first and second electrode plates 111 and 112, and the case 120 configured to accommodate the electrode assembly 110 therein.

The electrode assembly 110 can be manufactured in a jelly roll form by winding the first and second electrode plates 111 and 112 and the separator 13, which can be laminated to each other. The electrode assembly 110 can be manufactured in a stack form by stacking a plurality of first and second electrode plates 111 and 112 and a plurality of separator 113. Alternately, the electrode assembly 110 can be manufactured using both the winding and stacking processes.

The first electrode plate 111 includes a first active material coating portion (not shown) and a first non-coating portion 111a. The first active material coating portion can formed by intermittently coating a first active material on a first base material that is a sheet-shaped conductive material. The first non-coating portion 111a is a portion at which the first active material is not coated so that the first base material is exposed. The first non-coating portion 111a can protrude to one side of the first electrode plate 111. For example, the first electrode plate 111 can be a positive electrode plate. The first active material can be a positive electrode active material including lithium such as LiCoO₂, LiNiO₂, LiMnO₂, LiMn₂O₄ or LiNi_{1-x-y}CoₓM_{y}O₂.

The second electrode plate 112 has a different polarity from the first electrode plate 111. The second electrode plate 112 includes a second active material coating portion (not shown) and a second non-coating portion 112a. The second active coating material coating portion can be formed by intermittently coating a second active material on a second base material that is a sheet-shaped conductive material. The second non-coating portion 112a is a portion at which the second active material is not coated so that the second base material is exposed. The second non-coating portion 112a can protrude to one side of the second electrode plate 112. For example, the second electrode plate 112 can be a negative electrode plate. The second active material can be a positive electrode active material including a carbon material such as crystalline carbon, amorphous carbon, carbon composite or carbon fiber, lithium metal, or lithium alloy.

The separator 113 is interposed between the first and second electrode plates 111 and 112, and insulates the first and second electrode plates 111 and 112 from each other. The separator 113 enables lithium ions to be exchanged between the first and second electrode plates 111 and 112. The separator 113 can be formed to a sufficient length to completely insulate the first and second electrode plates 111 and 112 from each other even though the electrode assembly 110 is contracted and expanded. For example, the separator 113 can be as long as the first and second electrode plates 111 and 112.

The first and second electrode plates 111 and 112 can discharge ions into the electrolyte to generate a flow of current or electrons, and the current or electrons is/are transferred to an electronic device electrically connected to the electrode assembly 110. The first non-coating portion 111a can be a positive electrode, and the second non-coating portion 112a can be a negative electrode. The first and second electrode tabs 121 and 122 are respectively connected to the first and second non-coating portions 111a and 112a. An insulating tape 114 can be provided in one area of each of the first and second electrode tabs 121 and 122 so as to prevent damage of the first and second electrode tabs 121 and 122 and maintain insulation of the first and second electrode tabs 121 and 122 from the case 120.

The case 120 can be formed of aluminum, and at least one or more surfaces of the case 120 can be coated with an insulating material so that the case 120 can be insulated. Although the described embodiment of the battery cell is a pouch-type lithium ion secondary battery, the described technology is not limited thereto, and can be applied to various types of batteries including a prismatic battery, a cylindrical battery, and the like.

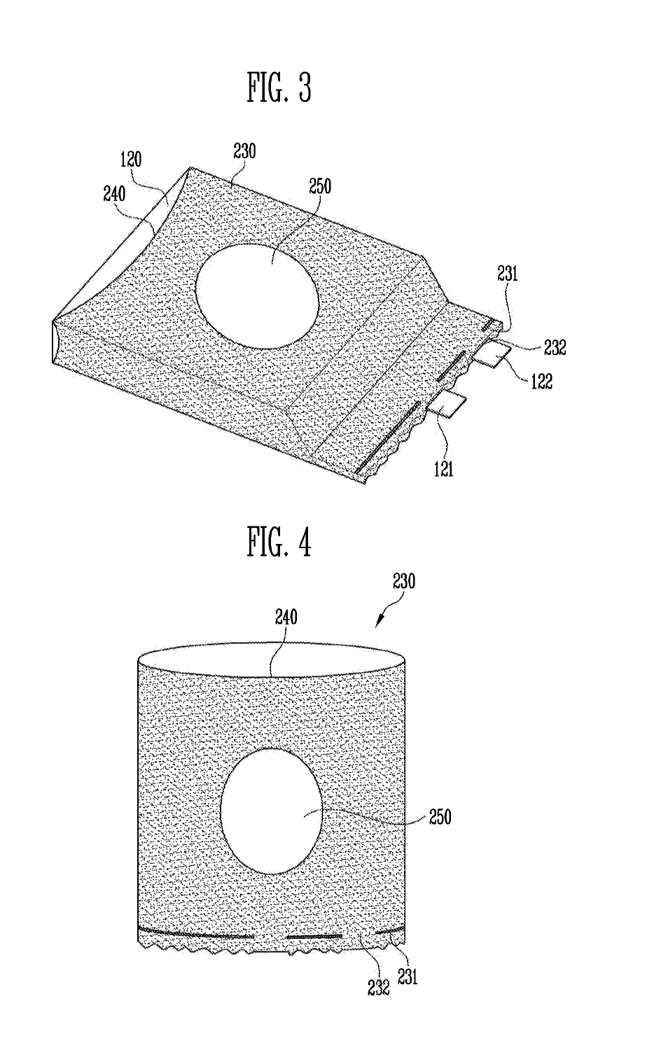

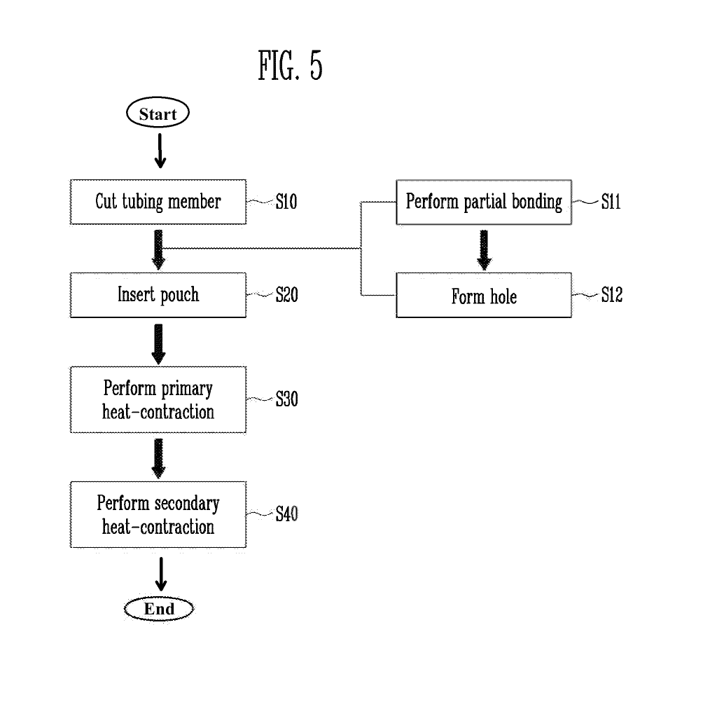

FIG. 3 is a perspective view showing a secondary battery according to another embodiment. FIG. 4 is a perspective view showing a tubing member of FIG. 3.

As shown in FIGS. 3 and 4, the tubing member 230 according to this embodiment surrounds an outer surface of the case 120 accommodating the electrode assembly 110 and an electrolyte therein, and has an opened lower portion. In some embodiments, an arch-shaped contraction portion 240 is formed at the lower portion of the tubing member 230 so as to prevent both interference between battery cells and an increase in the thickness of the secondary battery. In addition, an upper portion of the tubing member 230 can have a bonding area 231 and a non-bonding area 232. The first or second tab 121 or 122 can be exposed to the outside of the tubing member 230 in the non-bonding area 232. In some embodiments, the tubing member 230 is formed to at least partially cover the insulating tape 114 of the first or second electrode tab 121 or 122. For example, the bonding of the tubing member 230 is performed by an ultrasonic or high-frequency bonding machine in the bonding area 231. The width of the bonding area 231 can be within about 1 mm so as to prevent the interference and short circuit of the battery cell with a protective circuit module and an electronic device.

A hole 250 can be further formed in at least one surface of the tubing member 230. In some embodiments, one or more holes 250 is formed in a first surface corresponding to a relatively wide surface among the surfaces of the case 120. For example, the hole 250 can be formed in the first surface corresponding to a relatively large surface among the surfaces of the case 120 to provide elasticity to the tubing member 230. Accordingly, some space between the tubing member 230 and the battery cell can be secured by elasticity of the tubing member 230 in thermal expansion of the battery cell.

As described above, the secondary battery of the described technology is surrounded by the tubing member made of an insulating material, not to be exposed to the outside. Thus, it is possible to prevent an electrical short circuit of the secondary battery with the protective circuit module and the electronic device, thereby improving the safety of the secondary battery.

Hereinafter, a method for manufacturing the secondary battery of the described technology will be described.

FIG. 5 is a flowchart illustrating a method for manufacturing the secondary battery.

In step S10, a wound tubing member is cut to a predetermined length.

The wound tubing member can be cut substantially equal to or slightly longer than the height of a battery cell. If the tubing member is cut shorter than the height of the battery cell, an exposure portion of the case increases through a step of performing a heat-contraction process, which will be described later, and therefore, a cutting portion of the case in the exposure portion can be corroded. If the tubing member is cut excessively longer than the height of the battery cell, a loose area is generated at an upper or lower portion of the battery cell, and therefore, the thickness of the battery cell can increase.

The tubing member is an insulating member, and is formed of polyethyleneterephthalate (PET) or polyimide (PI). The tubing member can insulate, be waterproof and protect from exterior forces (e.g., falling on the ground).

Next, after the step of cutting the tubing member, a step of partially bonding one area of the cut tubing member (S11) or a step of forming a hole in one area of the cut tubing member (S12) can be additionally performed.

The partial bonding can be performed in other areas except areas respectively corresponding to the first and second electrode tabs of the battery cell. The partial bonding can be performed by a high-frequency or ultrasonic bonding machine. During this step, the first and second electrode tabs of the battery cell can be exposed to the outside of the tubing member. The width of the bonded area in the tubing member can be within about 1 mm so that interference of the bonded area with a peripheral member does not occur.

The hole is formed in an elliptical shape at a central portion of the tubing member, and thus can provide elasticity to the tubing member. For example, if thermal expansion occurs due to overcharging or discharging of the battery cell, some space between the battery cell and the tubing member can be secured by the elasticity of the tubing member.

In step S20, the battery cell is inserted into the tubing member.

Air is injected into the tubing member through the lower portion of the tubing member so that the battery cell is easily inserted into the tubing member cut in the step S10. When some space is provided in the tubing member by injecting the air into the tubing member, the battery cell is inserted into the tubing member. Although it has been illustrated in this figure that the battery cell is a pouch type battery cell, the described technology is not limited thereto, and can be applied to all types of batteries, regardless of its shape such as a prismatic or cylindrical shape.

In step S30, the tubing member is primarily heat-contracted by applying heat to upper and lower portions of the battery cell inserted into the tubing member.

When the insertion of the battery cell into the tubing member is completed in the step S20, the upper and lower portions of the battery cell are heated using a heater. Specifically, heat is applied to the tubing member at a temperature of about 200° C. to about 240° C., for about 2 seconds to about 8 seconds so that the tubing member is adhered closely to upper and lower portions of the case of the battery cell while being heat-contracted. When the temperature of the heat is less than about 200° C., the temperature is lower than the glass transition temperature Tg of the tubing member, and therefore, the tubing member is not heat-contracted. If the temperature of the heat exceeds about 240° C., the heat can have a negative effect on the electrode assembly and other elements. However, depending on embodiments, the temperature can be less than about 200° C. or greater than about 240° C.

In step S40, the primarily heat-contracted tubing member is secondarily heat contracted.

When the primary heat-contraction process is completed in the step S30, the tubing member is heat-contracted under a thermostat of about 200° C. to about 240° C. so that the tubing member is substantially entirely adhered closely to the surface of the case of the battery cell. If the temperature of the thermostat is less than about 200° C., the temperature is lower than the glass transition temperature Tg of the tubing member, and therefore, the tubing member is not heat-contracted. If the temperature of the thermostat exceeds about 240° C., the heat can have a negative effect on the electrode assembly and other elements. However, depending on embodiments, the temperature can be less than about 200° C. or greater than about 240° C.

When the step of performing the secondary heat-contraction process of FIG. 5 is completed, the secondary battery of the described technology is formed.

In the secondary battery tubed by the manufacturing method, the primary and secondary heat-contraction processes are respectively performed by different methods, so that the contraction ratio of the tubing member can be minimized. Accordingly, it is possible to prevent the ionization of aluminum in the case and the occurrence of a side reaction between the aluminum and the electrolyte, thereby preventing corrosion of the secondary battery.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment can be used singly or in combination with features, characteristics, and/or elements described in connection with other embodiments unless otherwise specifically indicated. Accordingly, it will be understood by those of skill in the art that various changes in form and details can be made without departing from the spirit and scope of the present invention as set forth in the following claims.

What is claimed is:

1. A secondary battery, comprising:
an electrode assembly including first and second electrode tabs;
a case accommodating the electrode assembly and an electrolyte therein, wherein the case includes first and second sides opposing each other; and
a tubing member surrounding an outer surface of the case, wherein the tubing member has first and second openings respectively exposing the first and second sides of the case.

2. The secondary battery of claim 1, further comprising a contraction portion formed adjacent to one of the first and second openings of the tubing member.

3. The secondary battery of claim 2, wherein the contraction portion has an arch shape.

4. The secondary battery of claim 1, wherein one side of the tubing member includes i) a bonding area in which the tubing member is bonded to the case and ii) a non-bonding area in which the tubing member is not bonded, and
wherein the first and second electrode tabs are exposed to the exterior of the tubing member in the non-bonding area.

5. The secondary battery of claim 1, wherein the tubing member has at least one third opening formed between the first and second openings.

6. The secondary battery of claim 5, wherein the third opening has a shape different from the first and second openings.

7. The secondary battery of claim 5, wherein the third opening has an elliptical shape.

8. The secondary battery of claim 1, wherein the tubing member is formed of polyethyleneterephthalate (PET) or polyimide (PI).

9. The secondary battery of claim 1, wherein the case is a prismatic or pouch-type case.

10. The secondary battery of claim 1, wherein the first opening is greater in size than the second opening.

11. The secondary battery of claim 1, wherein the first and second electrode tabs are formed in the second opening.

12. A method for manufacturing a secondary battery, the method comprising:
cutting a wound tubing member to a predetermined length;
inserting a battery cell including first and second electrode tabs into the cut tubing member;
performing a primary heat-contraction process on the tubing member, wherein the primary heat-contraction process comprises applying heat to upper and lower portions of the battery cell; and
performing a secondary heat-contraction process on the tubing member, wherein the secondary heat-contraction process comprises applying heat to substantially the entire surface of the battery cell.

13. The method of claim 12, wherein the primary heat-contraction process is performed with a temperature of about 200° C. to about 240° C. for about 2 seconds to about 8 seconds.

14. The method of claim 12, wherein the secondary heat-contraction process is performed with a temperature of about 200° C. to about 240° C.

15. The method of claim 12, further comprising partially bonding one area of the cut tubing member.

16. The method of claim 15, wherein the partially bonding is performed in areas except for areas corresponding to the first and second electrode tabs.

17. The method of claim 12, further comprising forming an opening in at least one surface of the cut tubing member.

18. The method of claim 17, wherein the opening is formed at a central portion of the tubing member.

19. The method of claim 17, wherein the opening is between the upper and lower portions of the battery cell.

20. The method of claim 12, wherein the tubing member is formed of polyethyleneterephthalate (PET) or polyimide (PI).
